(19) United States
(12) Patent Application Publication
(10) Pub. No.: US 2016/0240016 A1
(43) Pub. Date: Aug. 18, 2016

(54) Method of Managing Usage Fares for a Transportation System

(71) Applicant: Marc M. Ranpour, Potomac, MD (US)

(72) Inventor: Marc M. Ranpour, Potomac, MD (US)

(21) Appl. No.: 15/092,944

(22) Filed: Apr. 7, 2016

Related U.S. Application Data
(63) Continuation-in-part of application No. 15/046,443, filed on Feb. 17, 2016, now abandoned.
(60) Provisional application No. 62/117,120, filed on Feb. 17, 2015.

(51) Int. Cl. G07B 15/02; G06Q 10/02; G06Q 50/30

(52) U.S. Cl. CPC G07B 15/02; G06Q 50/30; G06Q 10/02

(57) ABSTRACT

A method of managing usage fares for a transportation system is executed through at least one remote server and a plurality of transportation access points. Each transportation access point is any kind of gate where a fare is charged in order for a passenger to gain access to a service within a transportation system. The method begins by receiving identification information from a user trying to access an arbitrary access point from the transportation access points. The identification information is received through a physical scanner of the arbitrary access point and is then sent to the remote server so that that the remote server can calculate a fare amount for the user. If the user's available balance is greater than or equal to the fare amount, then the remote server deducts the fare amount from the user's available balance and sends an access-granted notification to the arbitrary access point.

The current application is a continuation-in-part (CIP) application of a U.S non-provisional application Ser. No. 15/046,446 filed on Feb. 17, 2016. The U.S. non-provisional application Ser. No. 15/046,446 claims a priority to a U.S. provisional application Ser. No. 62/117,120 filed on Feb. 17, 2015.

### FIELD OF THE INVENTION

The present invention generally relates to transportation fare management, and more specifically, fare management systems that use mobile devices having wireless interfaces communicating fare information.

### BACKGROUND OF THE INVENTION

People all around various regions use different forms of public transportation. Some even use multiple transportation modes in a single day, such as a train, and then a bus. To use public transportation, users need to pay for each transportation mode separately, and often each mode will be associated with its own fare card, such as a bus fare card or a metro fare card. Therefore, users are often juggling multiple fare cards for multiple forms of transportations.

Therefore, there exists a need for a system that allows for users to be able to travel using different transportation modes without having to worry about carrying fare cards for each mode.

### BRIEF DESCRIPTION OF THE DRAWINGS

FIG. 1 is a block diagram depicting the communication between the remote server and a mobile computing device or a physical ticket via the plurality of transportation access points.

FIG. 2 is a flowchart depicting the overall process for managing usage fares for a transportation system.

FIG. 3 is a flowchart thereof, further depicting the alternative steps for sending an access-denied notification to the user.

FIG. 4 is a flowchart thereof, further depicting the steps for increasing the available balance for the user.

FIG. 5 is a flowchart thereof, further depicting the steps for determining a fixed fare.

FIG. 6 is a flowchart thereof, further depicting the steps for determining a fixed fare that is dynamically adjusted by the present invention.

FIG. 7 is a flowchart thereof, further depicting the steps for determining a variable fare at an entrance access point.

FIG. 8 is a flowchart thereof, further depicting the steps for determining a variable fare at an exit access point.

FIG. 9 is a flowchart thereof, further depicting the steps for determining a variable fare at an exit access point that is dynamically adjusted by the present invention.

FIG. 10 a flowchart thereof, further depicting the steps for retrieving an authentication code from a mobile computing device.

FIG. 11 is a flowchart thereof, further depicting the steps of generating and sending a new authentication code to a mobile computing device.

FIG. 12 a flowchart thereof, further depicting the steps for reading an authentication code off of a physical ticket.

FIG. 13 is a flowchart thereof, further depicting the steps of printing a new authentication code onto a new physical ticket.

FIG. 14 is a flowchart thereof, further depicting the steps of authenticating a user account with one of the plurality of subscriber profiles.

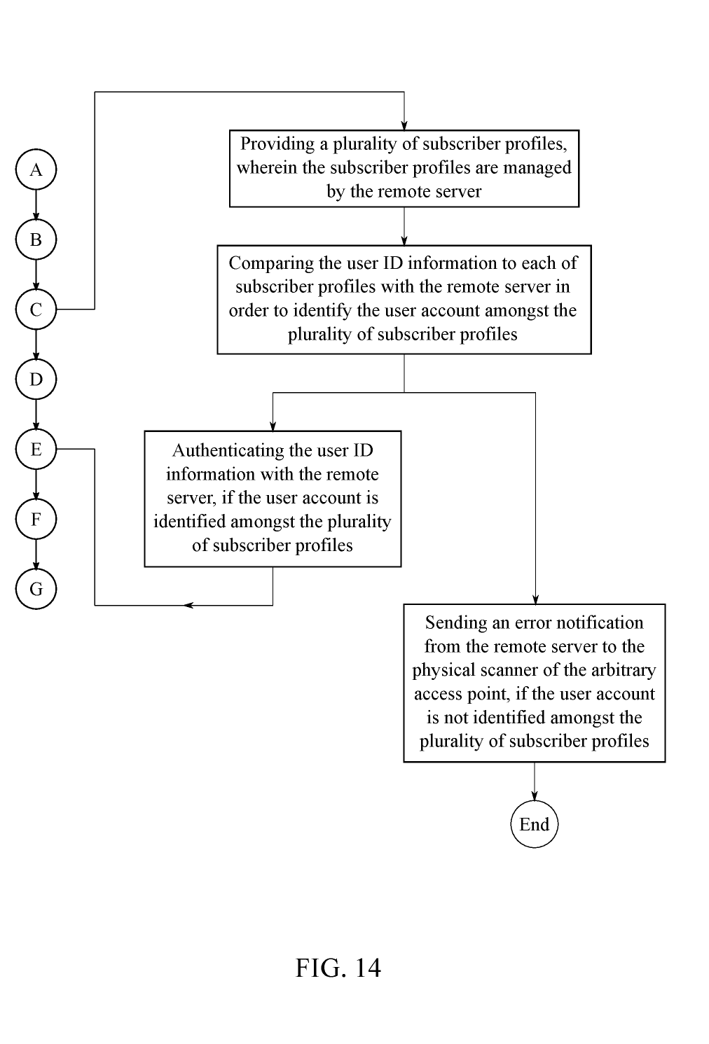

FIG. 15 is a flowchart thereof, further depicting the steps of outputting the access-granted notification through either a physical scanner or a mobile computing device.

FIG. 16 is a flowchart thereof, further depicting the steps of recording the geospatial location of a mobile computing device as the user travels through the transportation system.

### DETAILED DESCRIPTION OF THE INVENTION

All illustrations of the drawings are for the purpose of describing selected versions of the present invention and are not intended to limit the scope of the present invention.

The present invention is a method of managing usage fares for a transportation system. The present invention conveniently allows a user to pay fares at any access point in the transportation system with a mobile computing device such as a smartphone or a tablet personal computer. However, the present invention still allows the user to pay fares at any access point with a physical ticket. A transportation access point within the transportation system is defined as a point where the user can pay a fare to access a transportation service within the transportation system. A transportation access point can be, but is not limited to, the fare collecting console on a public bus, the entrance gate of a subway station, the exit gate of a subway station, and the ticket booth at a train station. Each transportation access point is associated with a set of fare rules, which describe how a fare amount is calculated at that particular access point. The set of fare rules can be configured to, but is not limited to, calculate a fixed fare, a variable fare, a fixed-dynamic fare, or a variable-dynamic fare.

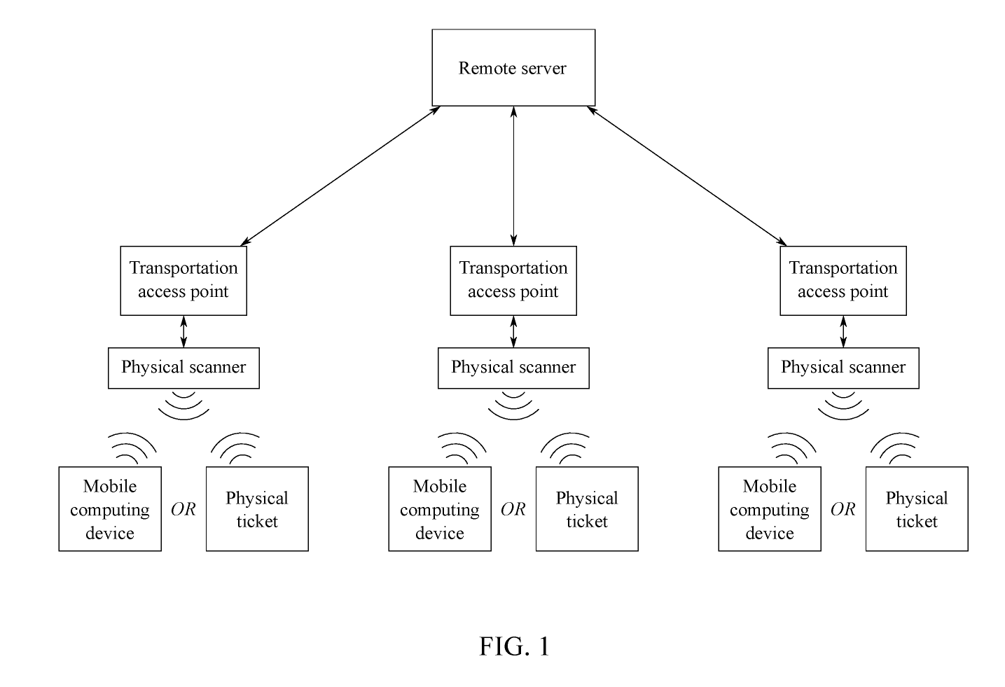

As can be seen in FIG. 1, the system used to execute the steps of the present invention allows a large number of users to interact with the plurality of transportation access points. The system includes a physical scanner for each transportation access point (Step A), which allows the user to input the necessary information with either a mobile computing device or a physical ticket. The physical scanner is preferably configured to read a quick response (QR) code, to use a near field communication (NFC) signal, or to receive a radio-frequency identification (RFID) signal. The system also includes at least one remote server that is used to keep track of an available balance for each user and is used to manage other administrative processes of the present invention (Step B). The available balance is a record of the available funds that can be used to pay a fare at one of the transportation access points.

The overall process followed by the method of the present invention is described with respect to one user interacting the present invention through a single user account.

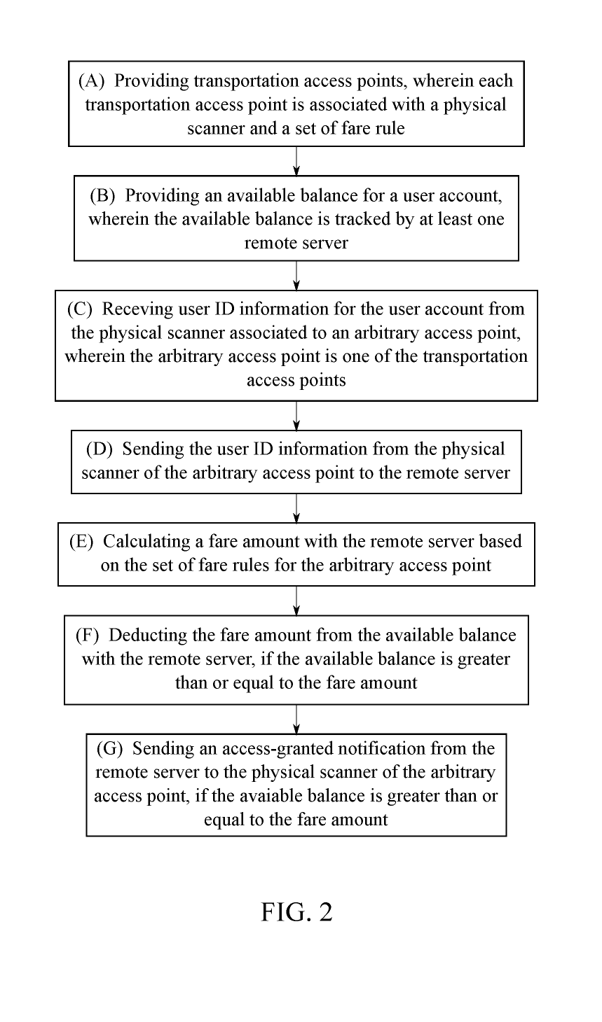

The user account allows the present invention to distinguish one user from another user and provides a means for a user to interact with the present invention. As can be seen in FIG. 2, the overall process begins by receiving user identification (ID) information for the user account from the physical scanner associated to an arbitrary access point (Step C). The user ID information allows the present invention to distinguish one user from another user and typically includes the user's name, the user's date of birth, and/or other pieces of information to uniquely distinguish the user. The arbitrary access point can be any one of the plurality of transportation access points. The overall process continues by sending the user ID information from the physical scanner to the remote server (Step D), which allows the present invention to check the available balance of the user account. The overall process proceeds by calculating a fare amount with the remote server based on the set of fare rules for the arbitrary access point (Step E). The set of fare rules defines how the fare amount is calculated by the remote server, and some embodiments of the set of fare rules are described below.

In the ideal situation, if the available balance of the user account is greater than or equal to the fare amount, then the present invention deducts the fare amount from the available balance of the user account with the remote server (Step F). This allows the present invention to remotely charge the user for using a transportation service within the transportation system that is managed by the present invention. If Step F occurs during the overall process, then the present invention also sends an access-granted notification from the remote server to the physical scanner (Step G), which notifies the user that they may proceed to use the transportation service.

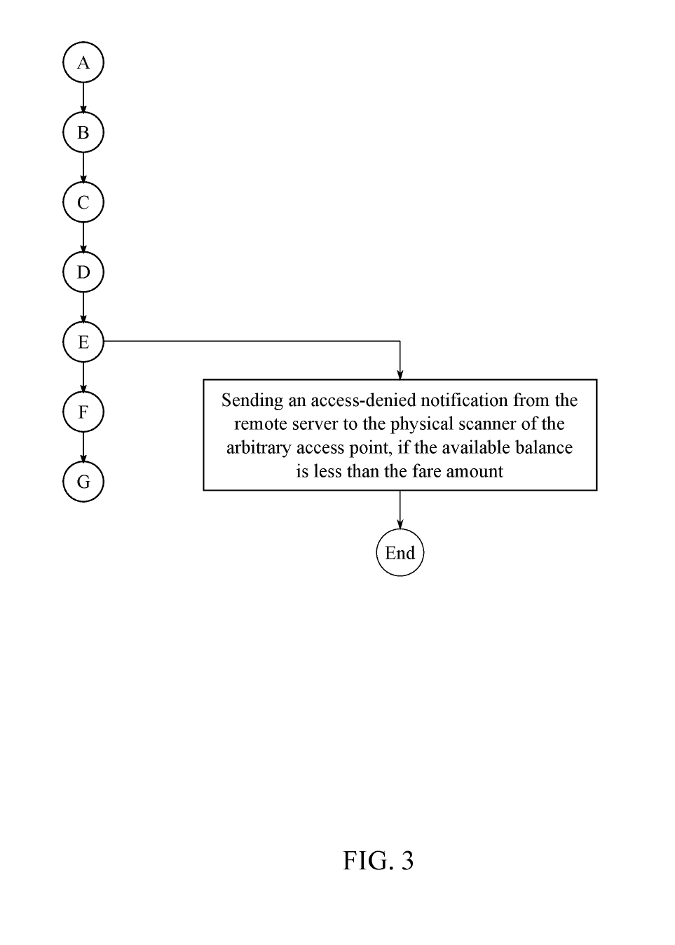

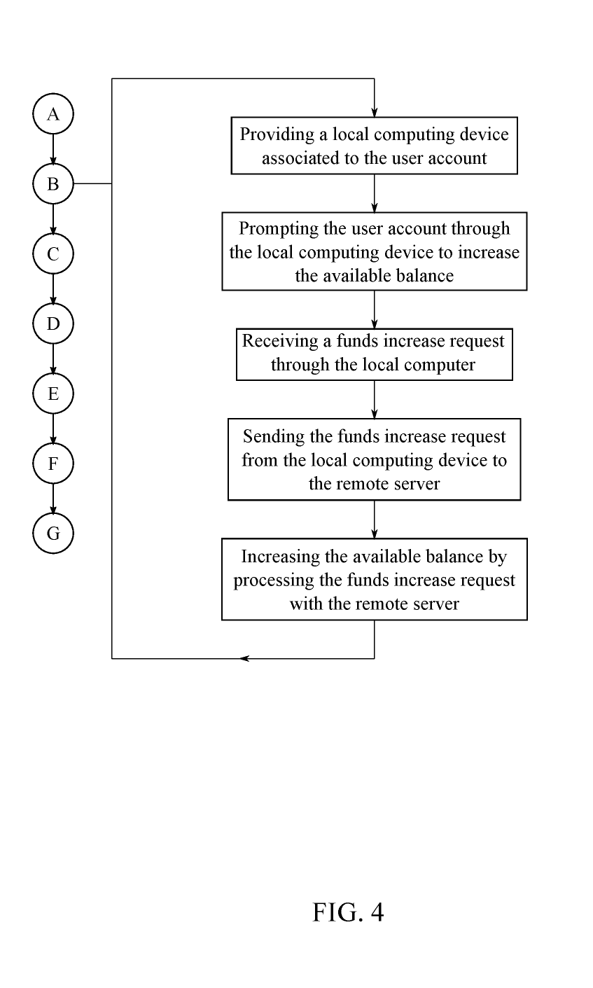

In an unideal situation shown in FIG. 3, if the available balance of the user account is less than the fare amount, the present invention sends an access-denied notification from the remote server to the physical scanner, which notifies the user that more funds need to be added to their available balance. The present invention allows the user to access their available balance and add funds to their available balance through any local computing device, which is shown in FIG. 4. For example, funds can be added to their available balance through a website displayed on a home desktop computer, wherein the home desktop computer is the local computing device, or funds can be added to their available balance through a mobile software application displayed on a smartphone, wherein the smartphone is the local computing device. More specifically, the present invention prompts the user account to increase the available balance through the local computing device and receives a funds increase request from the local computing device. The funds increase request indicates by how much the user wants to increase the available balance. The funds increase request is then sent from the local computing device to the remote server so that the present invention can increase the available balance by processing the funds increase request. The funds increase request can be processed through, but is not limited to, one of the following methods: credit card or online payment service (e.g. PayPal).

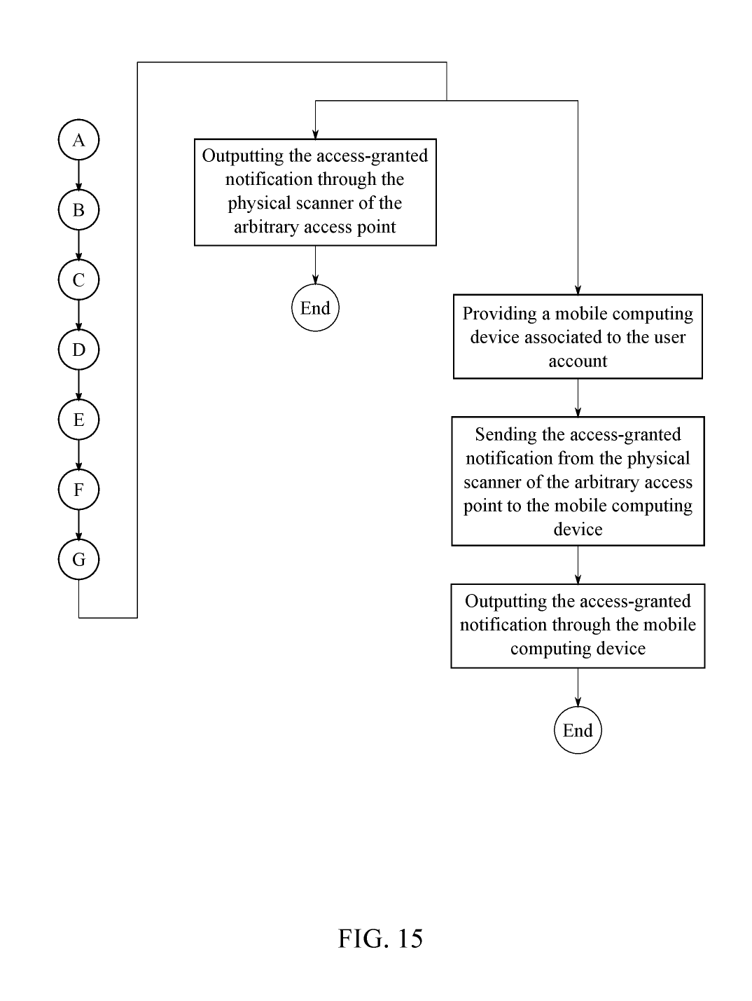

In addition, the access-granted notification can be outputted to the user in two different ways after Step G. One way illustrated in FIG. 15 is to simply output the access-granted notification through the physical scanner so that the access-granted notification can be readily viewed by the user. The other way illustrated in FIG. 15 is to send the access-granted notification from the physical scanner to a mobile computing device that is associated to the user account and then to output the access-granted notification on the mobile computing device, which can be, but is not limited to, a smartphone or a tablet personal computer.

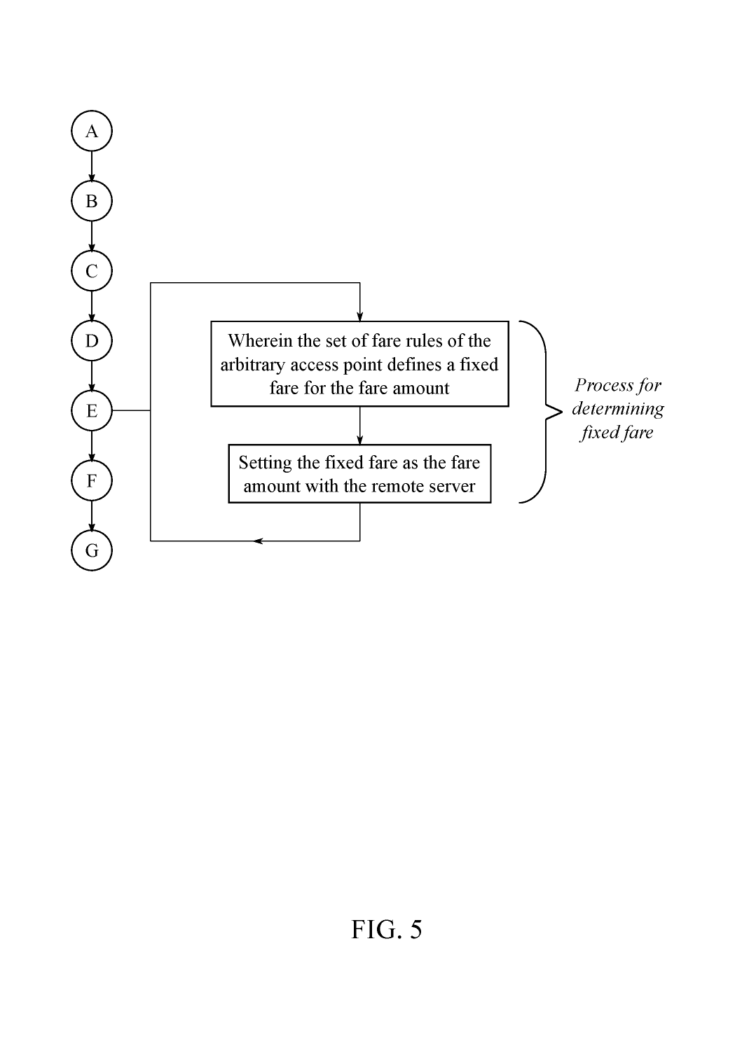

Again, the set of fare rules defines how the fare amount is calculated by the remote server. In one embodiment depicted in FIG. 5, the set of fare rules for the arbitrary access point defines a fixed fare for the fare amount. Thus, in this embodiment, the present invention sets the fixed fare as the fare amount with the remote server during Step E. One example for this embodiment of the set of fare rules is the transportation system that allows a user to pay one fixed fare to ride the bus regardless of the number of transfers between different bus routes.

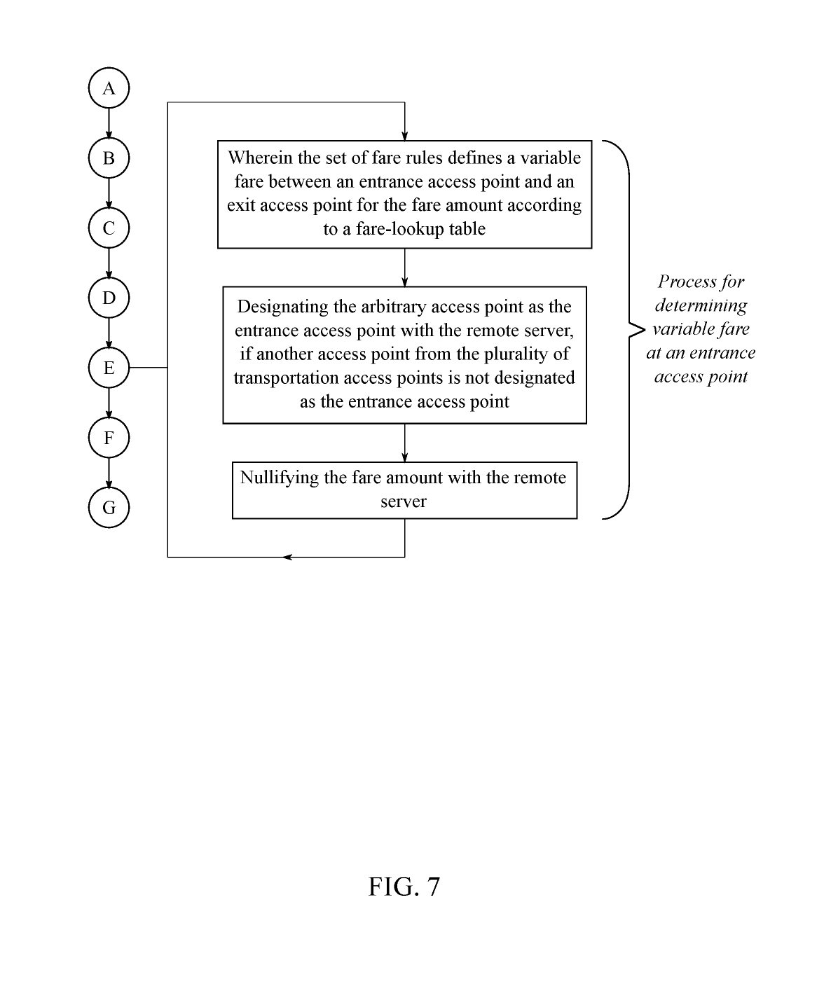

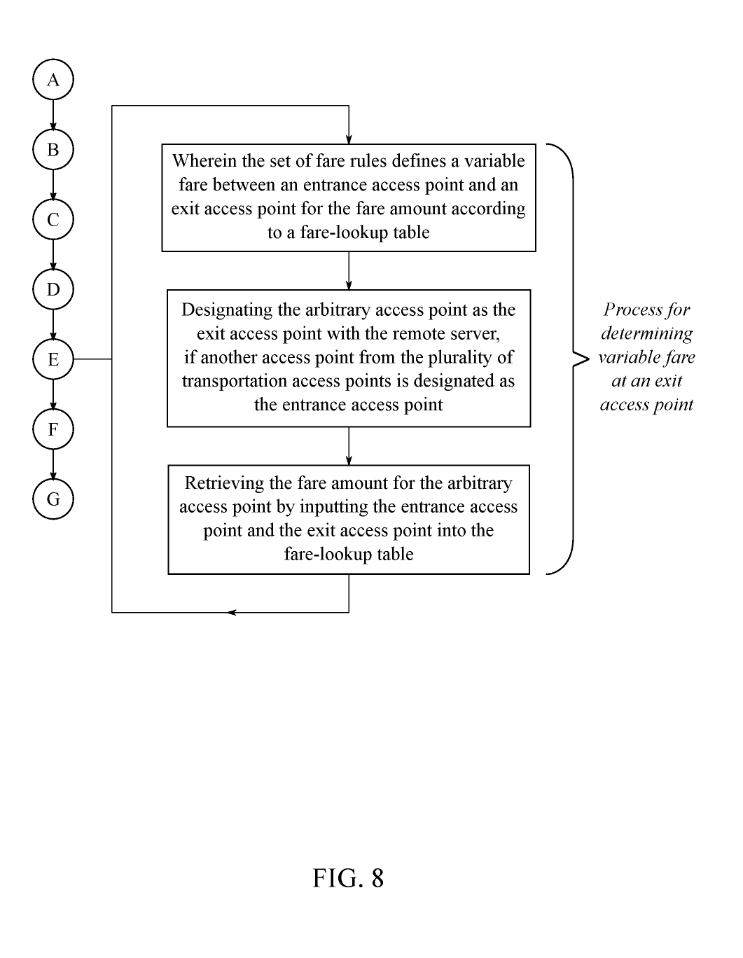

In another embodiment shown in FIGS. 7 and 8, the set of fare rules for the arbitrary access point varies the fare amount between an entrance access point and an exit access point according to a fare lookup table. The entrance access point is where the user begins to use a transportation service within the transportation system, and the exit access point is where the user stops using the transportation service. The fare lookup table provides a fare amount for every trip that can be taken by a passenger within the transportation service. Typically, fare amounts on the fare lookup table are proportionately dependent on the physical distance between the entrance access point and the exit access point, but the fare amounts on the fare lookup table can be dependent on other factors as well. Also for this embodiment, the present invention needs to determine if the arbitrary access point is either an entrance access point or an exit access point. As can be seen in FIG. 7, if another access point from the plurality of transportation access points is not designated as the entrance access point, then the remote server designates the arbitrary access point as the entrance access point during Step E. Consequently, the present invention nullifies the fare amount with the remote server during Step E so that the user is automatically granted access through the arbitrary access point. As can be alternatively seen in FIG. 8, if another access point from the plurality of transportation access points is designated as the entrance access point, then the remote server designates the arbitrary access point as the exit access point during Step E. Consequently, the remote server retrieves the fare amount for the arbitrary access point from the fare-lookup table during Step E by inputting the entrance access point and the exit access point into the fare-lookup table so that the user is charged the fare amount at the end of their trip on the transportation service. A real-world example of this embodiment is a subway or train transportation system, where the value of trip is proportionate to the distance travelled by the passenger.

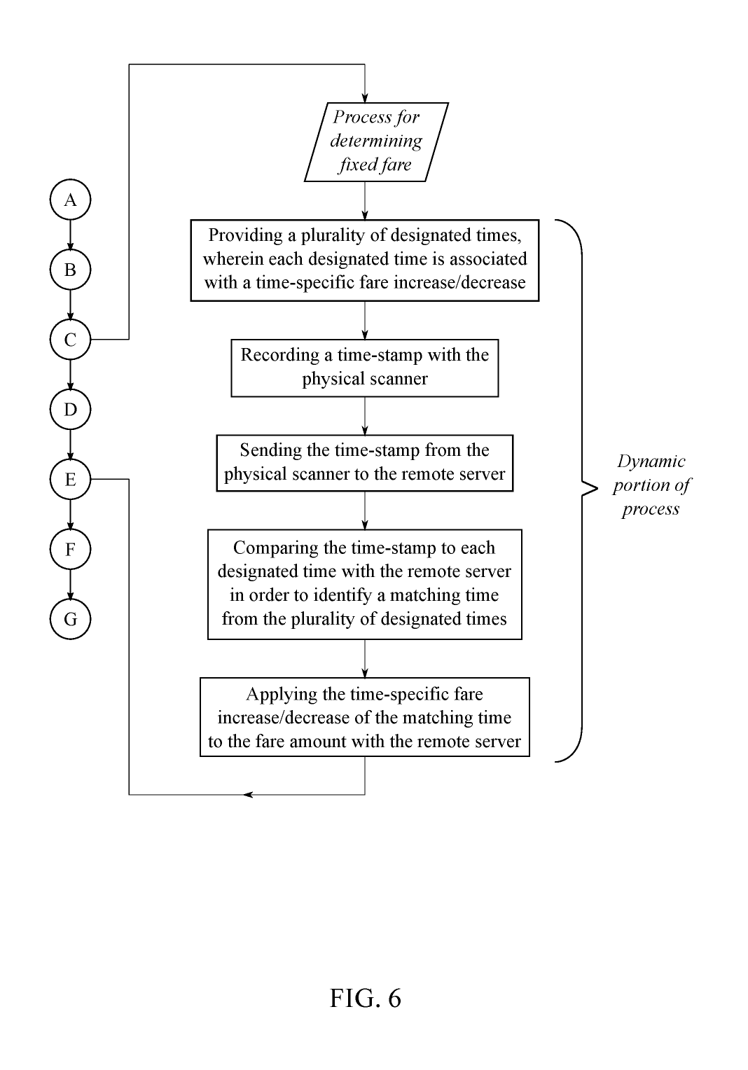

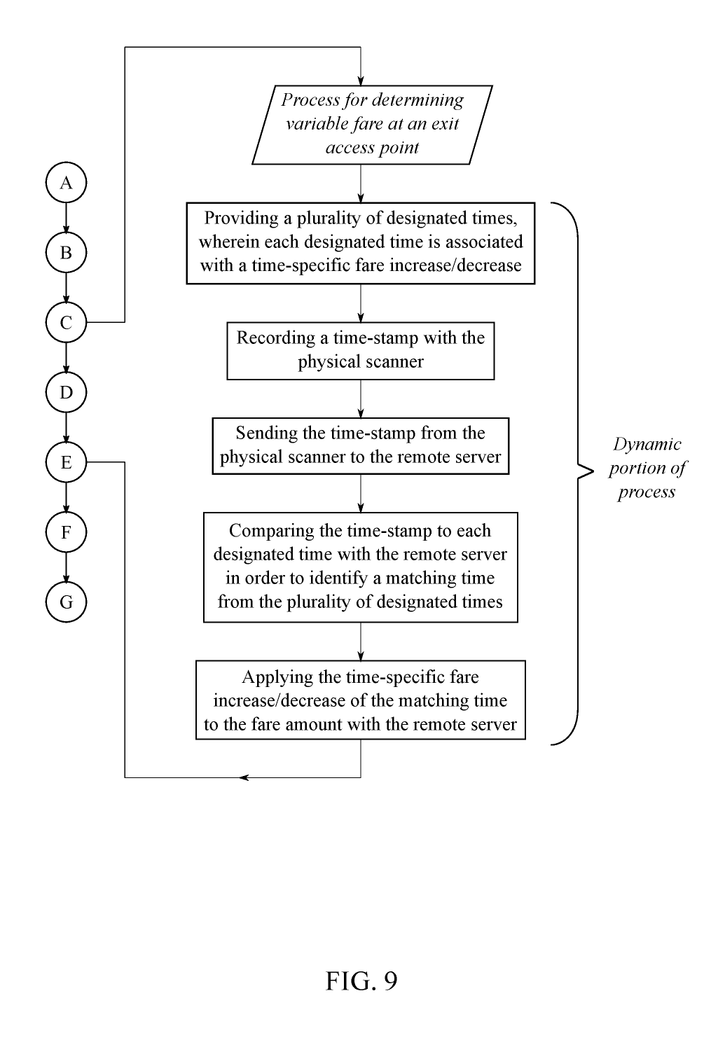

Whether the fare amount is assessed through a fixed fare (FIG. 6) or a variable fare (FIG. 9), the set of fare rules for the arbitrary access point also uses a plurality of designated times to further increase or decrease the fare amount. Each designated time is a time period that is known to have an increase or decrease of passenger traffic such as during rush hour, during the weekend, or during a holiday. In addition, each designated time is associated with a time-specific fare increase/decrease, which typically is dependent on the amount of passenger traffic during its respective time. For example, if one of the designated times is rush hour, then the present invention would apply a time-specific fare increase to the fare amount. The process to apply a time-specific fare increase/decrease to the fare amount begins by recording a time-stamp with the physical scanner during Step C so that the present invention is able to determine at what exact time the user tried to pass through the arbitrary access point. The time-stamp is sent with the user ID information during Step D from the physical scanner of the arbitrary access point to the remote server, which allows the remote server to compare the time-stamp to each designated time during Step E in order to identify a matching time from the plurality of designated times. The remote server can then apply the time-specific fare increase/decrease of the matching time to the fare amount during Step E so that the user is charged the proper fare amount based on when the user accessed the transportation system.

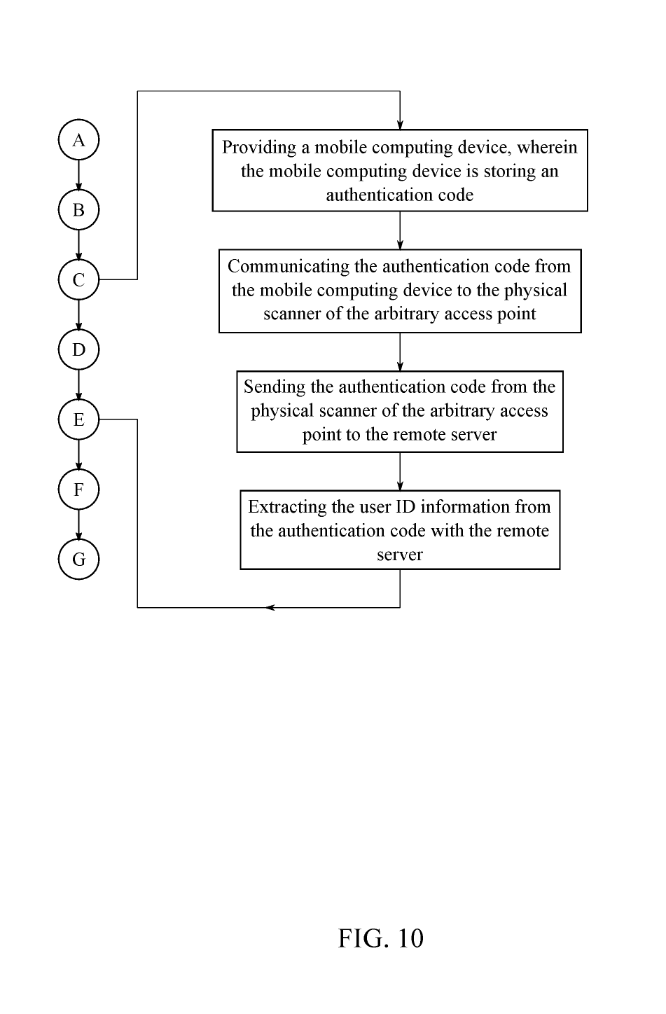

Moreover, the present invention allows for a user to input their user ID information into the physical scanner of the arbitrary access point through either a mobile computing device or a physical ticket. As can be seen in FIG. 10, the mobile computing device needs to store an authentication code, which is an encoded version of the user ID information. The authentication code can be transmitted in, but is not limited to, one of the following methods: a QR code, an NFC signal, or an RFID signal. The authentication code is communicated from the mobile computing device to the physical scanner of the arbitrary access point during Step C, which allows for a secure transmission of the user ID information between the mobile computing device and the physical scanner of the arbitrary access point and reduces the probability of the user ID information from being stolen. The authentication code is then sent from the physical scanner to the remote server during Step D, which allows for a secure transmission of the user ID information between the physical scanner of the arbitrary access point and the remote server and again reduces the probability of the user ID information from being stolen. Finally, the remote server can decode or extract the user ID information from the authentication code before Step E so the present invention can then carry out the remaining steps of the overall process.

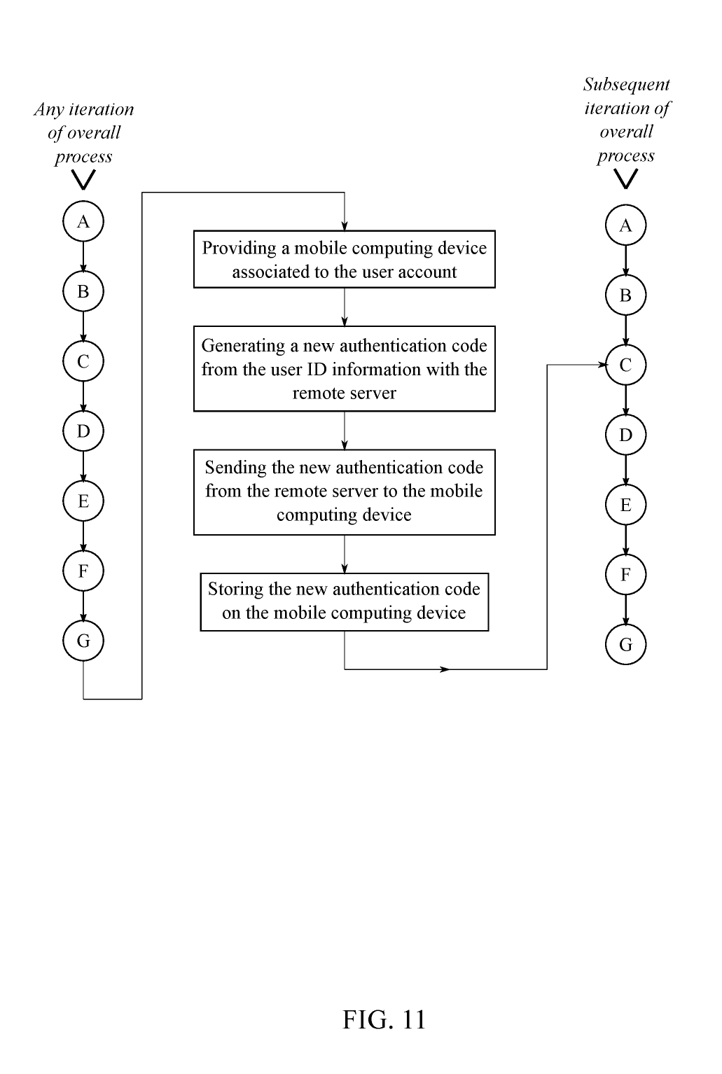

In order to maintain the security of the user ID information stored on a mobile computing device, the present invention updates the authentication code with a new authentication code during each reiteration of the overall process, which is shown in FIG. 11. Thus, the remote server begins by generating the new authentication code from the user ID information after Step G. The new authentication code is sent from the remote server to a mobile computing device that has been established as being associated with the user account such as by inputting user login information into the mobile application running on the mobile computing device. The new authentication code is then stored on the mobile computing device so that the new authentication code can be securely communicated to another access point from the plurality of transportation access point during a subsequent iteration of the overall process. In a practical example of the present invention, a QR code displayed on a mobile computing device is read by the physical scanner of the arbitrary access point during Step C, and a new QR code is generated by the remote server and sent back to the mobile computing device after the completion of Step G.

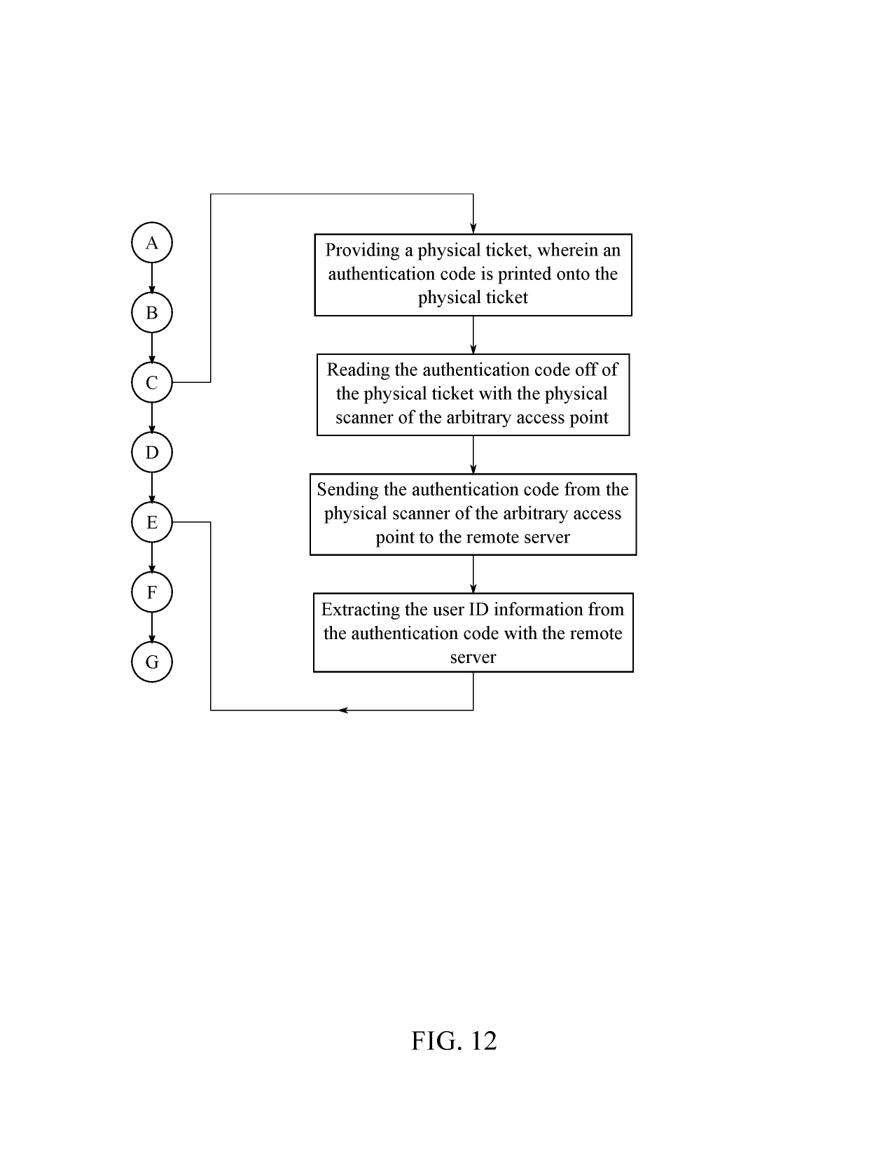

Alternatively, the authentication code can be printed onto a physical ticket, which allows the present invention to accommodate users that are hesitant to switch over to a virtual ticket managed by their mobile computing device. As can be seen in FIG. 12, if a user has a physical ticket, then the physical scanner of the arbitrary access point reads the authentication code off of the physical ticket in order to execute a secure transmission of the user ID information between the physical ticket and the physical scanner of the arbitrary access point. Similar to the process of retrieving the authentication code from the mobile computing device, the authentication code is then sent from the physical scanner to the remote server during Step D so that the remote server can decode or extract the user ID information from the authentication code before Step E.

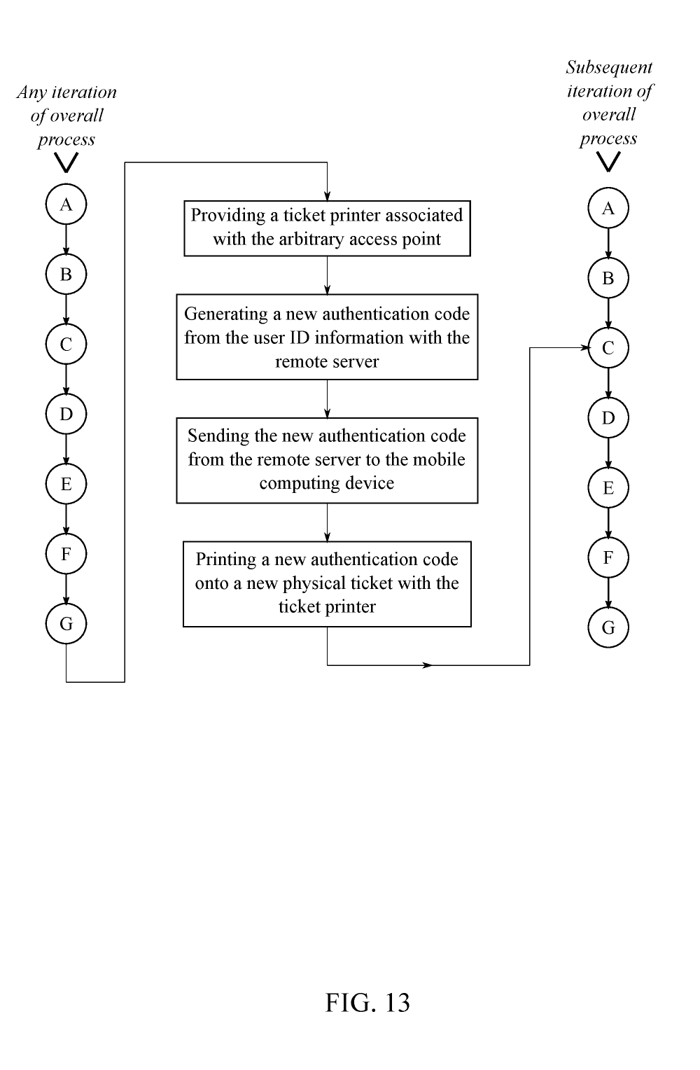

Also similar to the process of retrieving the authentication code from the mobile computing device, the present invention updates the authentication code with a new authentication code during each reiteration of the overall process in order to maintain the security of the user ID information printed on a physical ticket, which is shown in FIG. 13. Thus, the remote server begins by generating the new authentication code from the user ID information after Step G. The new authentication code is sent from the remote server to a ticket printer that has been established as being associated with the physical scanner of the arbitrary access point such as an electronic ticket booth at the same transportation hub as the physical scanner of the arbitrary access point. The new authentication code is then printed onto a new physical ticket so that the new authentication code can be securely communicated to another access point from the plurality of transportation access point during a subsequent iteration of the overall process. In a practical example of the present invention, each transportation access point is able to accept an authentication code stored on a mobile computing device and is able to accept the authentication code printed onto a paper ticket with a magnetic stripe.

The present invention is designed to manage information from a large number of users. Thus, the present invention distinguishes these multiple users by generating a subscriber profile for each user. This plurality of subscriber profiles is managed by the remote server and can be used to authenticate the user ID information of the user account as can be seen in FIG. 15. The present invention compares the user ID information to the each of the subscriber profiles with the remote server after Step D in order to identify the user account amongst the plurality of subscriber profiles. Thus, if the user account is identified amongst the plurality of subscriber profiles, the present invention is able to authenticate the user ID information with the remote sever. Alternatively, if the user account is not identified amongst the plurality of subscriber profiles, the present invention sends an error notification from the remote server to the physical scanner so that the user is notified of this error and is able to take measures to resolve the error.

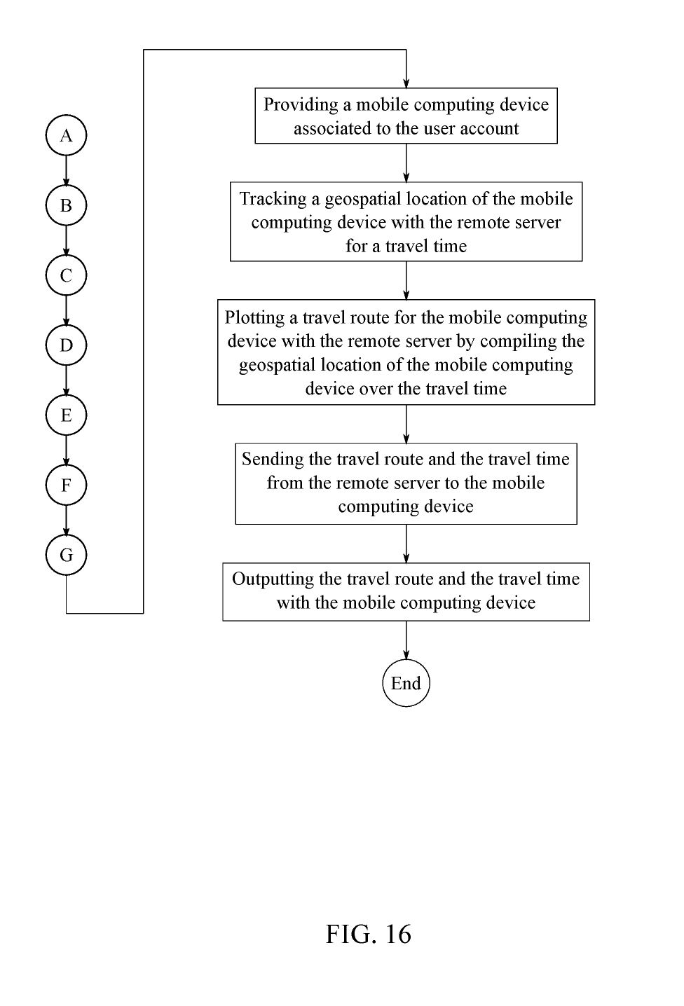

An ancillary feature of the present invention allows a user to track their geospatial location through their mobile computing device while the user is travelling on a transportation service within the transportation system. As can be seen in FIG. 16, the remote server begins this process by tracking the geospatial location of the mobile computing device associated with the user account for a travel time after Step G. The geospatial location can be obtained through the global positioning system (GPS) feature of the mobile computing device. The travel time is the time period between when the user starts and stops travelling on the transportation service. From these two pieces of information, the remote server is able to plot a travel route for the mobile computing device by compiling the geospatial location of the mobile computing device over the travel time. The travel route is a course of where the mobile computing device has gone within the transportation system. The remote server can then send the travel route and the travel time to the mobile computing device so that the travel route and the travel time can be outputted through the mobile computing device and can be viewed by the user. The travel route and the travel time can be outputted through the mobile computing device either as a live stream while the user is still travelling on their trip or as a trip summary after the user completes their trip on the transportation service.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, i.e., one or more modules of computer program instructions encoded on a computer readable medium for execution by, or to control the operation of, a data processing apparatus. The computer readable medium can be a machine-readable storage device, a machine-readable storage substrate, a memory device, a composition of matter affecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, or a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although the invention has been explained in relation to its preferred embodiment, it is to be understood that many other possible modifications and variations can be made without departing from the spirit and scope of the invention as hereinafter claimed.

What is claimed is:

1. A method of managing usage fares for a transportation system, the method comprises the steps of:
(A)providing a plurality of transportation access points, wherein each of the transportation access points is associated with a physical scanner and a set of fare rules;
(B) providing an available balance for a user account, wherein the available balance is tracked by at least one remote server;
(C) receiving user identification (ID) information for the user account from the physical scanner associated to an arbitrary access point, wherein the arbitrary access point is one of the transportation access points;
(D) sending the user ID information from the physical scanner of the arbitrary access point to the remote server;
(E) calculating a fare amount with the remote server based on the set of fare rules for the arbitrary access point;
(F) deducting the fare amount from the available balance with the remote server, if the available balance is greater than or equal to the fare amount; and
(G) sending an access-granted notification from the remote server to the physical scanner of the arbitrary access point, if the available balance is greater than or equal to the fare amount.

2. The method of managing usage fares for a transportation system, the method as claimed in claim 1 comprises the step of:
sending an access-denied notification from the remote server to the physical scanner of the arbitrary access point after step (E),
if the available balance is less than the fare amount.

3. The method of managing usage fares for a transportation system, the method as claimed in claim 1 comprises the steps of:
providing a local computing device associated to the user account;
prompting the user account through the local computing device to increase the available balance;
receiving a funds increase request through the local computing device;
sending the funds increase request from the local computing device to the remote server; and
increasing the available balance by processing the funds increase request with the remote server.

4. The method of managing usage fares for a transportation system, the method as claimed in claim 1 comprises the steps of:
wherein the set of fare rules of the arbitrary access point defines a fixed fare for the fare amount; and
setting the fixed fare as the fare amount with the remote server during step (E).

5. The method of managing usage fares for a transportation system, the method as claimed in claim 2 comprises the steps of:
providing a plurality of designated times, wherein each of the designated times is associated with a time-specific fare increase/decrease;
recording a time-stamp with the physical scanner during step (C);
sending the time-stamp from the physical scanner to the remote server during step (D);
comparing the time-stamp to each of the designated times with the remote server during step (E) in order to identify a matching time from the plurality of designated times; and
applying the time-specific fare increase/decrease of the matching time to the fare amount with the remote server during step (E).

6. The method of managing usage fares for a transportation system, the method as claimed in claim 1 comprises the steps of:
wherein the set of fare rules defines a variable fare between an entrance access point and an exit access point for the fare amount according to a fare-lookup table;
designating the arbitrary access point as the entrance access point with the remote server during step (E),
if another access point from the plurality of transportation access points is not designated as the entrance access point; and
nullifying the fare amount with the remote server during step (E).

7. The method of managing usage fares for a transportation system, the method as claimed in claim 1 comprises the steps of:
wherein the set of fare rules varies the fare amount between an entrance access point and an exit access point according to a fare-lookup table;
designating the arbitrary access point as the exit access point with the remote server during step (E),
if another access point from the plurality of transportation access points is designated as the entrance access point; and
retrieving the fare amount for the arbitrary access point from the fare-lookup table during step (E) by inputting the entrance access point and the exit access point into the fare-lookup table.

8. The method of managing usage fares for a transportation system, the method as claimed in claim 7 comprises the steps of:
providing a plurality of designated times, wherein each of the designated times is associated with a time-specific fare increase/decrease;
recording a time-stamp with the physical scanner during step (C);
sending the time-stamp from the physical scanner to the remote server during step (D);
comparing the time-stamp to each of the designated times with the remote server during step (E) in order to identify a matching time from the plurality of designated times; and
applying the time-specific fare increase/decrease of the matching time to the fare amount with the remote server during step (E).

9. The method of managing usage fares for a transportation system, the method as claimed in claim 1 comprises the steps of:
providing a mobile computing device, wherein the mobile computing device is storing an authentication code;
communicating the authentication code from the mobile computing device to the physical scanner of the arbitrary access point during step (C);
sending the authentication code from the physical scanner of the arbitrary access point to the remote server during step (D); and
extracting the user ID information from the authentication code with the remote server before step (E).

10. The method of managing usage fares for a transportation system, the method as claimed in claim 1 comprises the steps of:
providing a mobile computing device associated to the user account;
generating a new authentication code from the user ID information with the remote server after step (G);
sending the new authentication code from the remote server to the mobile computing device; and
storing the new authentication code on the mobile computing device.

11. The method of managing usage fares for a transportation system, the method as claimed in claim 1 comprises the steps of:
providing a physical ticket, wherein an authentication code is printed onto the physical ticket;
reading the authentication code off of the physical ticket with the physical scanner of the arbitrary access point during step (C);
sending the authentication code from the physical scanner of the arbitrary access point to the remote server during step (D); and
extracting the user ID information from the authentication code with the remote server before step (E).

12. The method of managing usage fares for a transportation system, the method as claimed in claim 1 comprises the steps of:
providing a ticket printer associated with the arbitrary access point;
generating a new authentication code from the user ID information with the remote server after step (G);
sending the new authentication code from the remote server to the arbitrary access point;
printing the new authentication code onto a new physical ticket with the ticket printer;

13. The method of managing usage fares for a transportation system, the method as claimed in claim 1 comprises the steps of:
providing a plurality of subscriber profiles, wherein the subscriber profiles are managed by the remote server;
comparing the user ID information to each of the subscriber profiles with the remote server after step (D) in order to identify the user account amongst the plurality of subscriber profiles;
authenticating the user ID information with the remote server, if the user account is identified amongst the plurality of subscriber profiles;
sending an error notification from the remote server to the physical scanner of the arbitrary access point,
if the user account is not identified amongst the plurality of subscriber profiles;

14. The method of managing usage fares for a transportation system, the method as claimed in claim 1 comprises the step of:
outputting the access-granted notification through the physical scanner of the arbitrary access point after step (G);

15. The method of managing usage fares for a transportation system, the method as claimed in claim 1 comprises the steps of:
providing a mobile computing device associated to the user account;
sending the access-granted notification from the physical scanner of the arbitrary access point to the mobile computing device after step (G);
outputting the access-granted notification through the mobile computing device;

16. The method of managing usage fares for a transportation system, the method as claimed in claim 1 comprises the steps of:
providing a mobile computing device associated to the user account;
tracking a geospatial location of the mobile computing device with the remote server for a travel time after step (G);
plotting a travel route for the mobile computing device with the remote server by compiling the geospatial location of the mobile computing device over the travel time;
sending the travel route and the travel time from the remote server to the mobile computing device;
outputting the travel route and the travel time with the mobile computing device;
